(19) United States
(12) Patent Application Publication
(10) Pub. No.: US 2012/0116882 A1
(43) Pub. Date: May 10, 2012

(54) ONLINE ADVERTISING TECHNIQUES UTILIZING TAXONOMICAL MAPPING

(75) Inventors: Mehul Sanghavi, Sunnyvale, CA (US); Grace Xiao, Palo Alto, CA (US)

(73) Assignee: Yahoo! Inc., Sunnyvale, CA (US)

(21) Appl. No.: 12/941,910

(22) Filed: Nov. 8, 2010

(51) Int. Cl. G06Q 30/00

(52) U.S. Cl. 705/14.55

(57) ABSTRACT

Techniques arc provided for allowing a user to cause a displayed advertisement to be replaced by an alternative advertisement. The user is provided with a graphical user interface that includes display of multiple user-selectable alternative advertisement topics or topical categories. The alternative advertisement topics or topical categories may be derived based on an advertisement taxonomy which relates to topics or topical categories of advertisements, and may be topically related to the displayed advertisement. Based at least in part on a selected alternative advertisement topic of topical category, an alternative advertisement is selected for display to the user.

### BACKGROUND

In online advertising, advertisements may be selected and displayed to particular users based on a variety of criteria, including many types of targeting. However, once an advertisement is selected and displayed, user involvement, selectivity or alternatives may be absent or limited.

There is a need for improved techniques for online advertising, such as techniques that allow for greater user involvement, selectivity or alternatives.

### SUMMARY

Some embodiments of the invention provide systems and methods that include allowing a user to cause a displayed advertisement to be replaced by an alternative advertisement. In some embodiments, the user is provided with a graphical user interface that includes display of multiple user-selectable alternative advertisement topics or topical categories. The alternative advertisement topics or topical categories may be derived based at least in part on an advertisement taxonomy which relates to topics or topical categories of advertisements, and may be topically related to the displayed advertisement. Based at least in part on a selected alternative advertisement topic of topical category, an alternative advertisement is selected for display to the user.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a block diagra ting one embodiment of the invention; and

FIG. 5 is a block diagram illustrating one embodiment of the invention.

While the invention is described with reference to tbo above drawings, thc drawings are intended to be illustrative, and the invention contemplates other embodiments within the spirit of the invention.

### DETAILED DESCRIPTION

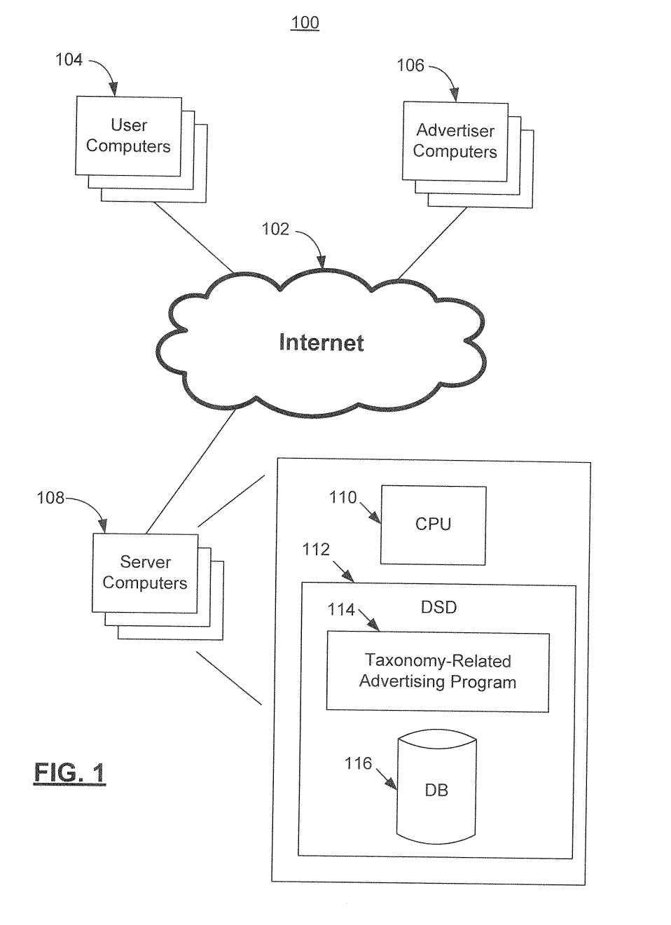

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which thc Internet is not included, as well as embodiments in which other networks are includedin addition to the Internet, including one more wireless networks, WANs, LANs, telephone, cell phone, or other data networks, etc. The invention further contemplates embodiments in ch user computers or other computers may bc or include wireless, portable, or handheld devices such as cell phones, PDAs, etc.

Each of the one or more computers 104, 106, lO0couyhcdkokibu1ed,mndoan include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various a ounts of memory including RAM and ROM. Depicted computers may also include various programming, applications, algorithms and software to enable searching, search results, and advertising, such as graphical or banner advertising as well as keyword searching and advertising in a sponsored search context, Many types of advertisements are contemplated, including textual advertisements, rich advertisements, video advertisements, etc.

Although each of the server computers 108 is depicted as including a database 116, it is o be understood that the depicted configuration is merely illustrative, and various other configurations are possible. For example, databases may be included within separate server computers, which may, for example, communicate with a Web server, such as via another server, etc.

As depicted, each of the server computers 108 includes one or more CPUs 110 and a data storage device 112. The data storage device 112 includes a database 116 and Taxonomy-Related Advertising Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

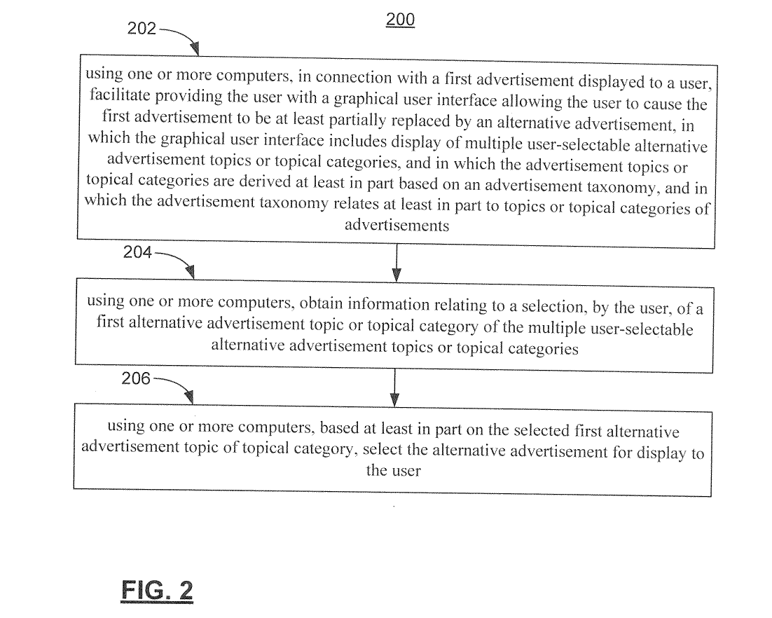

FIG. 2 is a flow diagram illustrating a method 200 according to one embodiment of the invention, At step 202, using one or more computers, in connection with a first advertisement displayed to a user, the mcthod 200 includes facilitating providing the user with a graphical use interface allowing the user to cause the first advertisement to be at least partially replaced by an alternative advertisement. The graphical user interface includes display of multiple user-selectable alternative advertisement topics or topical categories. The advertisement topics or topical categories are derived at least in part based on an advertisement taxonomy. The advertisement taxonomy relates at least in part to topics or topical categories of advertisements.

At step 204, using one or more computers, information is obtained relating to a selection, by the user, of a first alternative advertisement topic or topical category of the multiple uyc, mJcctoh|c alternative advertisement topics or topical categories.

At step 206, using one or more computers, based at least in part on the selected first alternative advertisement topic of topical category, the alternative advertisement is selected for display to the user.

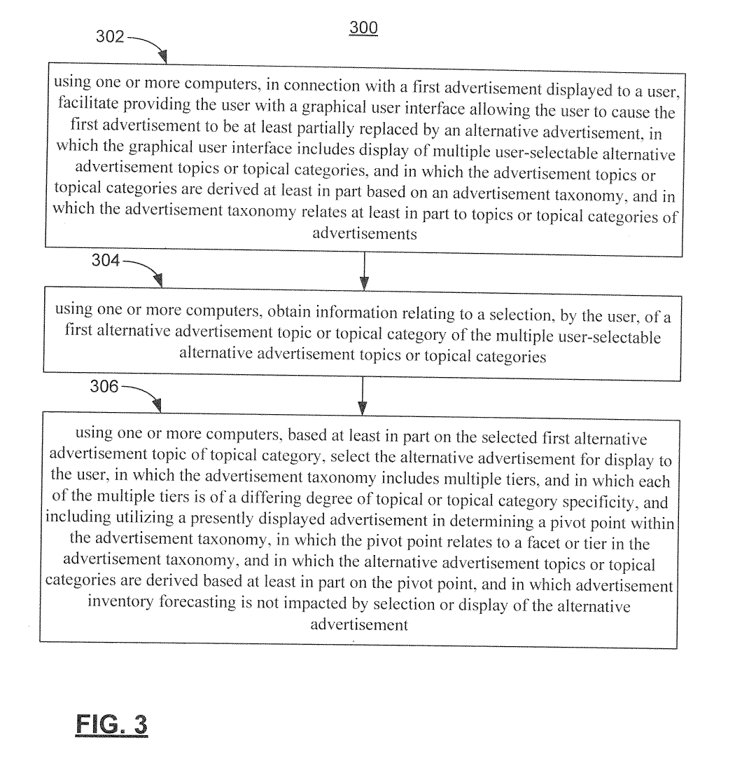

FIG. 3 is a flow diagram illustrating a method 300 according to one embodiment of the invention. Steps 302 and 304 are similar to steps 202 and 204 as depicted in FIG. 2.

At step 306, using one or more computers, based least in part on the selected first alternative advertisement topic of topical category, the alternative advertisement is selected for display to the user. Thc advertisement taxonomy includes multiple tiers, and each of the multiple tiers is of a differing degree of topical or topical category specificity. The method 300 includes utilizing a presently displayed advertisement in determining a pivot point within the advertisement taxonomy. The pivot point relates to a tier or facet in the advertisement taxonomy. The alternative advertisement topics or topical categories are derived based at least in part on the pivot point. Advertisement inventory forecasting is not impacted by selection or display of the alternative advertisement.

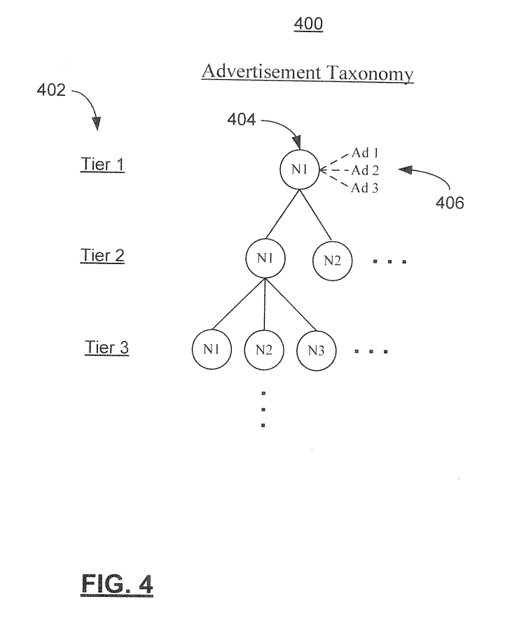

FIG. 4 is a block diagram 400 illustrating one embodiment of the invention. Particularly, FIG. 4 presents a simplified and partial illustration of an advertisement taxonomy according to somc embodiments of the invention. The taxonomy includes multiple tiers 402, each of which may include multiple nodes, such as node 404. Multiple advertisements 406 (which may include individual advertisements, advertisement groups, advertisement types, templates, etc.) may be associated with or categorized in each node, such as node 404 as depicted. Each tier, such as tier 1, tier 2, and tier 3, as depicted, may represent a topic (or set of topics or topical category (or set of topical categories). Each tier may represent or be associated with a different degree or level of specificity or granularity. For example, nodes in tier 3 may represent subtopics of nodes in tier 2, etc. Nodes may also be or be referred to as facets, and the location of an advertisement in the taxonomy may be represented or described as a path or mapping through the taxonomy. Traversing or partially traversing up through the taxonomy, such as from tier 3 to the general tier 2, for instance, may be referred to as reverse mapping.

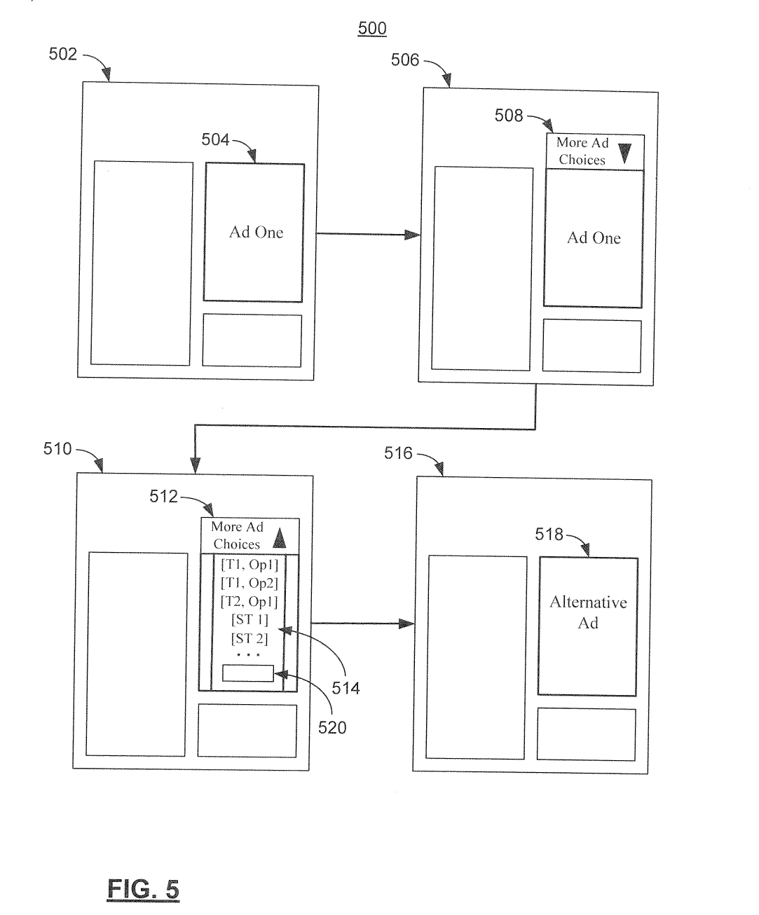

FIG. 5 is a block diagram 500 illustrating one embodiment of the invention. Particularly, FIG. presents a simplified and partial illustration of a series of screen displays according to some embodiments of the invention.

Display 502 includes, among o er hings, an online display advertisement, Ad One 504.

Display 506 includes a graphic 508 displayed above Ad One 504, although it could be displayed on a side of Ad One 504 or in other ways. In some embodiments, the graphic 508 may be displayed under various circumstances or in response to various triggers, such as if thc usc engages Ad One 504, such as by hovering over Ad One 504. Ad One 504 is still displayed at this point.

The graphic 508 may be an advertisement selector. If the user engages with the advertisement selector, an advertisement server or servers may return and cause display of a dynamically generated partial hierarchy of tiers and facets, with Ad One 504 indicating the pivot point. In some embodiments, the partial hierarchy may result from a reverse mapping from the faceting of Ad One 504. A representation of one example of this is provided by display 510, including graphic 512.

Display 516 results if the user selects one of the displayed facets of graphic 512 (which may include a topic, topical categories, or a particular associated advertisement, or information associated with any of the foregoing). In particular, Alternative Ad 518 is returned by the advertisement server or servers and displayed without reloading thc Web page, where the Alternative Ad 518 is associated with the selected facet, The Alternative Ad 518 replaces, or in some embodiments partially replaces, Ad One 504. The pivot point, such as for a e ly displayed advertisement selector, or for processing and downloading, is now changed to correspond to thc Alternative 518.

As depicted in display 510, various selections 514 may be presented to the user. These may include reverse-mapped facets using Ad One 504 as the pivot point. The selectable facets may include, for example, topics boch as represented by T1 or T2) options associated with topics (such as represented by Op1 and Op2), as well as subtopics (such as represented by ST 1 and ST 2), etc.

For example, an initially displayed advertisement may relate to a large SUV vehicle, such as a GMC Acadia. If displayed, selectable facets might include other vehicle class topics (hybrids, small SUVs, etc.), other large SUV GMC models, other large SUV makes, other large SUVmakes and models, etc. Of course, advertisements and facets may be selected based on various targeting parameters, including user targeting, geographic targeting, etc. Furthermore, based on targeting or other criteria, selectable facets may include a collection of various facets from the taxonomy, whether reverse or forward mapped, and may include specific advertisement type or even specific advertisements, etc.

Some embodiments of the invention allow a user who likes the product topic of a display advertisement being shown to him or her, but not that particular brand/advertiser/product, to be given an option to pick anoth advertisement, such as from a set of advertisers who have bookings at the same product topic/taxonomy faceting. In some embodiments, this selection of an alternative advertisement is user-triggered and can now be charged using a cost per click type model (CPC), such as from a cost per impression, or cost per a certain number of impressions, type model (CPM). The original impression may continue to be charged at a default CPM level, for example, This also results in an immediate highly engaged behavioral targeting (BT) profile for the particular topic in question for that given user.

In some embodiments, it is to be noted that, while c default advertisement taxonomy selection presented to the user revolves around the currently displayed advertisement topic, there is no restriction in showing the user a completely new topic tree based off similar or new BT targeting. Given that the original impression may have been delivered with some targeting criteria which the user has already been matched , thc default pivot point for the advertisement selector taxonomy is generally the one of the currently displayed advertisement.

In some embodiments, from a publisher's standpoint, the capability is provided for offering all the potential advertisements of a given broad or niche topic depending on the taxonomy traversal to the user. As a direct benefit, the publisher gains valuable extra impressions without directly increasing actual supply (page views).

In some embodiments, from an advertiser's standpoint, capability is provided to offer a highly engaged user-base who have sho nahighiotinterest in their brand/product. From a placement perspective, the standard display advertisement position is always available for the advertiser to buy on a given CPM (based on path, propert), demographics and targeting). However, this also allows “passive” advertisers to offer a set of advertisement creatives without getting charged for the same, thus extending standard display offering pay-per-performance/search type of advertisers.

From a display advertising perspective, some embodiments of the invention add a “user element” to the rim of any standard display advertisement position, When the page loads in the user's browser, the standard display advertisement positions are tilled with the advertisements booked against those paths. For each of the “enabled” advertisement positions, the advertisement server will do a reverse lookup based off the currcnt booked advertisement path. In taxonomy terms, this may start off a lower/leaf node and then traverse up a tree where additional advertisement bookings are made available. The user clement at the top then akes a navigable show/hide element appearwhich then lists all of the available, booked advertisements complete with advertiser name, product/brand name at custom geotargeted or BT targeted offers if any. Depending on publisher business rules, the navigation can be limited to a certain finite set of advertisements and up to a finite sct of reverse-taxonomy tiers traversal.

In some embodiments, the user can then click on any element within this navigation path and that will lead the advertisement server to return the selected advertiser's advertisement in the same advertisement position. The original advertisement, which is impression based, is counted and sent off to the advertisement prediction system as always, and is charged to the advertiser on a CPM basis. The newly selected advertisement is now charged on a per CPC basis regardless of a detection of a click in the advertisement.

In some embodiments, the reverse-faceted navigation user clement updates itself each time the user selects a new advertisement. The pivoting of the advertisement taxonomy tier is done based off the new advertisement selected. From an advertisement assembly and trafficking standpoint, thc “selected” advertisement is no different than the first advertisement which loads upon page load.

It is to be noted that, in some embodiments, as the advertisement server compiles additional BT profiling for the user based on the advertisement selection performed, it can also optimize the display of future advertisement displays in the default advertisement position to showcase the same brand/advertiser to which the user has shown an affinity.

Furthermore, it is noted that, in some embodiments, dc user element above the display advertisement can be a search input field instead of (or in addition to) a navigation tree. In this case, the user can be offered a type-ahead search function which will only display the advertisement categories (booked and available) at or around the taxonomy topic of the currently displayed advertisement.

As mentioned, some embodiments include switching from CPM to CPC when or after a user interacts or selects an alternative advertisement. This can be an advantage given the complication of tracking and forecasting that would be associated with a CPM model. Switching to the CPC model can mean that forecasting aspects arc no longer impacted. Furthermore, in some embodiments, a currently displayed advertisement provides the pivot point. The pivot point can be thc focus of and can be used in limiting, processing and downloading. For example, limitation can relate to only a certain set number of tiers up or down in the taxonomy from a tier associated with the pivot point. These aspects can lead to fastcr, more efficient processing and better practicality and performance.

As mentioned, e embodiments include providing a user search field for user selection of an alternative advertisement or advertisement topic, alternatively or additionally to a list or tree-type user interface for user selection of an alternative advertisement or topic. In some embodiments, the search function is limited to showing results from the a current active portion or “window” based on the taxonomy, as may be defined based on the pivot point, and advertisements are only returned from the window and that match the search. Furthermore, searching plus profiling can both be used in narrowing displayed selectable alternative advertisements or advertisement topics.

As depicted in FIG. 5, in some embodiments, a search box or field 520 may be included, for example, within a taxonomy tree. In some embodiments, the search field y be used by a user, as one example, if the user does not wish to or does not desire to spend time navigating the tree. Furthermore, the search field may include any of various suggestion features, For example, in some embodiments, when a user types a letter or several letters into the search field, all corresponding available advertisements may be listed, etc.

In some embodiments, capability associated with the search function can also bc used in providing a user with a backward navigation function in connection with displayed advertisements or advertisement topics. Saving of limited, pertinent state information can be performed that can make this practical. Displays, interfaces and options can be provided to users in connection with this.

In various embodiments, user selection of an alternative advertisement can include an advertisement associated with a narrower or more general topic than thc initial advertisement. Furthermore, in some embodiments, a uscr may be shown or may select an alternative advertisement from an entirely different portion of the taxonomy, and selections like this can be providing based on various targeting criteria.

In some embodiments, for “enabled” advertisement positions, thc advertisement serving system performs a “reverse” lookup, so that it loads information relating to higher tiers of the taxonomy, from a starting point of the taxonornical path of the initially displayed advertisement. In some embodiments, a user interface will list advertisements or advertisement topics from certain higher tiers, or a certain number of higher tiers, of the taxonomy. Furthermore, in some embodiments, a publisher can provide rules, such as rules that limit how many higher tiers are navigable to a user, or from which a user selection list in provided.

Although processing relating to use of taxonomies can bc difficult in terms of amount of processing and associated delays, some embodiments of the invention can provide a means to overcome this at least in part by use of pivot points in limiting processing and downloading, as described above. Processing and practicality can further be increased by switching to a CPC type model, so that impact is avoided on forecasting, inventory prediction, fulfillment of CPM type contracts, etc.

As described above, some embodiments of the invention present methodswhich offer the user various “dynamically painted” taxonomy trees. This dynamic set may be limited or bounded by the user's previously known profile characteristics (demographic, geographic, behavioral, etc.), which may computationally speed up the drawing dravviogofdbc tree. The limited set may also case the management of a large set of returned advertisements in any user interface. In some embodiments, however, the user can bc provided, for example, with access to an ‘All’ or ‘Un-targeted’ option in the taxonomy browser interface which may bring back the largest set of advertisements that the user can get access to, or can get access to at or above the currently s lected taxonomy facet. F rthermore, this particular scenario may be utilized when the user is relatively new to the network and there isn't much information collected when the user decides to use techniques according to embodiments of the invention. Furthermore, in some embodiments, the presentation of this type of feature or option (or the opposite, by disabling features according to embodiments of the invention for select new users, for example) may be at the prerogative of the publisher.

While the invention is described with reference to the above drawings, the drawings are intended to be illustrative, and the invention contemplates other embodiments within the spirit of thc invention.

1. A method comprising:
using one or more computers, in connection with a first advertisement displayed to a user, facilitating providing the user with a graphical user interface allowing the user to cause the first advertisement to be at least partially replaced by an alternative advertisement;
wherein the graphical user interface includes display of multiple user-selectable alternative advertisement topics or topical categories, and wherein the advertisement topics or topical categories are derived at least in part based on an advertisement taxonomy, and wherein the advertisement taxonomy relates at least in part to topics or topical categories of advertisements;
using one or morc computers, obtaining information relating to a selection, by the user, of a first alternative advertisement topic or topical category of the ultiple user-selectable alternative advertisement topics or topical categories; and
using one or more computers, based at least in part on the selected first alternative advertisement topic of topical category, selecting the alternative advertisement for display to the user.

2. Thc method of claim 1, comprising facilitating display of the alternative advertisement to the user.

3. The method of claim 1, comprising allowing the user to choose an alternative advertisement relating to a topic associated with the first advertisement, but relating to a different product, brand, or advertiser than the first advertisement.

4. The method of claim 1, comprising facilitating providing the user with thc graphical user interface, wherein the alternative topics or topical categories are related, in the advertisement taxonomy, to one or more topics or topical categories, in the advertisement taxonomy, of the first advertisement.

5. The method of claim 1, comprising selecting the alternative advertisement, wherein one or more topics or topical categories of the alternative advertisement are at least related, in the advertisement taxonomy, to one or more topics or topical categories, in the advertisement taxonomy, of the first advertisement.

6. The method of claim 1, comprising utilizing the advertisement taxonomy, wherein the advertisement taxonomy comprises multiple tiers, wherein each of the multiple tiers is of a differing degree of topical or topical category specificity.

7. The method of claim 1, comprising utilizing the advertisement taxonomy, wherein the advertisement taxonomy comprises multiple tiers, wherein each of the multiple tiers is of a differing degree of topical or topical category specificity, and comprising utilizing a presently displayed advertisement in determining a pivot point within the advertisement taxonomy.

8. The method of claim, cnroprisiug utilizing the advertisement taxonomy, wherein the advertisement taxonomy comprises multiple tiers, wherein each of the multiple tiers is of a differing degree of topical or topical category specificity, and comprising utilizing a presently displayed advertisement in determining a pivot point within the advertisement taxonomy, wherein the pivot point relates to a tier or facet in the advertisement taxonomy,

9. The method of claim 1, comprising utilizing the advertise ent axonomy, wherein the advertisement taxonomy comprises multiple tiers. wherein each of the multiple tiers is of a differing degree of topical or topical category specificity, and comprising utilizing a presently displayed advertisement in determining a pivot point within the advertisement taxonomy, wherein the pivot point relates to a tier in the advertisement taxonomy, and wherein the pivot point is utilized i ing processing associated with advertising,

10. The method of claim 1, comprising utilizing the advertisement taxonomy, wherein the advertisement taxonomy comprises multiple tiers, wherein each of the multiple tiers is of a differing degree of topical or topical category specificity, and comprising utilizing a presently displayed advertisement in determining a pivot point within the advertisement taxonomy, wherein the pivot point relates to a tier or facet in the advertisement taxonomy, and wherein the alternative advertisement topics or topical categories are derived based at least in part on the pivot point.

11. The method of claim 1, wherein, following the user causing the first advertisement to be at least partially replaced by an alternative advertisement, an associated advertising pricing scheme is switched from a cost per impressio type model to a cost per click type model.

12. The method of claim 1, comprising providing the user with a search field relating to alternative advertisement selection, or relating to alternative advertisement topic or topical category selection.

13. A system comprising:
one or more server computers coupled to a network; and
one or more databases coupled to the one or more server computers;
wherein the one or more server computers are for:
in connection with a first advertisement displayed to a user, facilitating providing the user with a graphical user interface allowing the user to cause the first advertisement to be at least partially replaced by an alternative advertisement;
wherein the graphical user intcrface includes display of multiple user-selectable alt rnativc advertisement topics or topical categories, and wherein the advertisement topics or topical categories are derived at least in part based on an advertisement taxonomy, and wherein the advertisement taxonomy relates at least in part to topics or topical categories of advertisements;
obtaining information relating to a selection, by the user, of a first alternative advertisement topic or topical category of thc iple user-selectable alternative advertisement topics or topical categories; and
based at least in part on the selected first alternative advertisement topic of topical category, selecting the alternative advertisement for display to the user.

14. The system of claim 13, wherein at least one of the one or more servers are coupled to the internet.

15. The system of claim 13, comprising serving the alternative advertisement.

16. The system of claim 13, comprising storing the alternative advertisement in at least one of the one or more databases,

17. The system of claim 13, comprising al ( iser to choose an alternative advertisement relating to a topic associated with the first advertisement, but relating to a different product, brand, or advertiser than the first advertisement.

18. The system of claim 13, comprising facilitating providing the user with the graphical user interface, wherein the alternative topics or topical categories are related, in the advertisement taxonomy, to one or more topics or topical categories, in the advertisement taxonomy, of the first advertisement.

19. The system of claim 13, comprising selecting the alternative advertisement, wherein one or more topics or topical categories of the alternative advertisement are related, in the advertisement taxonomy, to one or more topics or topical categories, in the advertisement taxonomy, of the first advertisement.

20. A co p e readable medium or media containing instructions for executing a method comprising:
using one or more computers, in connection with a first advertisciTient displayed to a user, facilitating providing the user with a graphical user interface alio ing the user to cause the first advertisement to be at least partially replaced by an alternative advertisement;
wherein the graphical user interface includes display of multiple user-selectable alternative advertisement topics or topical categories, and wherein the advertisement topics or topical categories are derived at least in part based on an advertisement taxonomy, and wherein the advertisement taxonomy relates at least in part to topics or topical categories of advertisements;
using one or more computers, obtaining information relating to a selection, by the user, of a first alternative advertisement topic or topical category of the multiple user-selectable alternative advertisement topics or topical categories; and
using one or more coolputcos, based at least in part on the selected first alternative advertisement topic of topical category, selecting the alternative advertisement for display to thc user;
wherein the advertisement taxonomy comprises multiple tiers, herein each of the multiple tiers is of a differing degree of topical or topical category specificity, and comprising utilizing a presently displayed advertisement in determining a pivot point within the advertisement taxonomy, wherein the pivot point relates to a tier or facet in the advertisement taxonomy, and wherein the alternative advertisement topics or topical categories arc derived based at least in part on the pivot point, and wherein advertisement inventory forecasting is not impacted by selection or display of the alternative advertisement.
